(19) United States
(12) Patent Application Publication
(10) Pub. No.: US 2006/0163245 A1
(43) Pub. Date: Jul. 27, 2006

(54) Shrinking device

(76) Inventor: Christian Pfau, Bietigheim-Bissingen (DE)

Correspondence Address: POSZ LAW GROUP, PLC, 12040 SOUTH LAKES DRIVE, SUITE 101, RESTON, VA, 20191, US

(21) Appl. No.: 10/533,911

(22) PCT Filed: Aug. 26, 2003
(86) PCT No.: PCT/EP03/09419

§ 371 Date: May 5, 2005

(30) Foreign Application Priority Data
Nov. 13, 2002 (DE) 102 53 106.4

(51) Int. Cl. H05B 6/10

(52) U.S. Cl. 219/635

(57) ABSTRACT

The invention relates to a shrinking device (2, 70) for shrinking a tool (12) into a tool holder (11, 68) of a tool chuck (10), said device comprising a heating device (14, 52, 72) for heating the tool holder (11, 68). The invention is characterised in that the shrinking device (2, 70) comprises a gas suction unit (16) for evacuating the gases (32, 84) that escape from the tool holder (11, 68).

### PRIOR ART

The invention relates to a shrinking device and to a method for shrinking a tool into a tool holder of a tool chuck.

When a tool is shrunk, the tool is thermally clamped into a tool holder of a tool chuck, as a result of which a very firm and highly precise fixing of the tool, for example a drill, milling cutter or the like, in the tool holder can be achieved. In this case, the tool holder, which has, for example, a hole for receiving a tool shank, is heated, so that the tool holder expands. The tool is inserted by its shank into the hole enlarged by this means. During subsequent cooling, the tool shank is held frictionally in the tool holder, which is shrunk on account of the cooling. The diameters of the hole of the tool holder and of the shank of the tool are selected here in such a manner that a frictional and rotationally fixed connection is produced during cooling. Tools shrunk in such a manner are used in metal machining and at speeds of rotation of over 10 000 revolutions per minute.

DE 100 24 423 A1 discloses a shrinking device for shrinking a tool into a tool holder, which device has an induction coil as the heating device for heating the tool holder.

The invention is based, in particular, on the object of specifying an improved shrinking device in comparison to known shrinking devices. This object is achieved by the features of patent claim 1. Further refinements emerge from the subclaims.

### ADVANTAGES OF THE INVENTION

The invention is based on a shrinking device for shrinking a tool into a tool holder of a tool chuck, having a heating device for heating the tool holder. It is proposed that the shrinking device comprises a gas suction device for evacuating gases escaping from the tool holder.

Over the course of time, a multiplicity of tools are shrunk into a tool chuck. These tools are used together with the tool chuck during a machining operation on a workpiece. In this connection, the tools are generally wetted with a cooling or cutting liquid, usually with a special oil or with an emulsion. The liquid flows along the outside of the tool or through cooling ducts in the interior of the tool. As a rule, this liquid also comes into contact with the tool chuck which also can likewise be provided with cooling ducts. After use, the tool is unshrunk from the tool holder by the tool holder being heated again, in which case the hole of the tool holder is enlarged and the tool with its shank can be pulled out of the tool holder. Residues of a liquid in or on the tool or in or on the tool holder are heated at the same time in this case. The shrinking or unshrinking temperature is usually around approx. 250° C. and therefore above the boiling temperature of the normally used cooling or cutting liquids. The liquid residues at least partially evaporate and propagate in the surroundings of the shrinking device. The evaporating gases rising out of the tool holder or from the surface of the tool do not always smell pleasant and may even constitute a health risk.

With a gas suction device, which is arranged on the tool holder and is intended for evacuating gases escaping from the tool holder, these gases can be guided away from the tool holder and supplied to a filter. The gases are at least predominantly removed from the ambient air and can be supplied to a cleaning process. The gas suction device is expediently arranged on the heating device or the tool chuck and/or can be connected to them. It suffices here if part of the gas suction device is arranged on the tool chuck or on the heating device and/or can be connected to them.

The gas suction device has a fan for generating a pressure or a negative pressure and expediently it has a gas-cleaning device or filter device. It is also possible to supply the evaporating gases in uncleaned form to a container or to a surrounding region situated at a distance. The gas suction device can be considered as belonging to the shrinking device at least insofar as a gas inlet opening of the gas suction device can be assigned directly to the shrinking device. This gas inlet opening can be positioned in the direct vicinity of a holder opening of the tool holder, so that the gases which rise from the tool or out of the tool holder and are charged with liquid vapor are at least predominantly sucked into the gas inlet opening. An escape of the gases into the surroundings is effectively counteracted.

The shrinking device expediently comprises a gas-conducting unit for conducting gas from the holder opening of the tool holder to a gas inlet opening of the gas suction device. With a gas-conducting unit, vapors arising at various locations can be conducted to the gas inlet opening, so that, for example, just one gas inlet opening can be used to evacuate vapors rising from surfaces at different orientations from one another or from relatively large surfaces. The gas-conducting unit may be a funnel which opens into the gas inlet opening, or it may be a structure which is designed in a different manner, at least partially encompasses a gas volume and through which the encompassed gas volume is directed to the gas inlet opening during the operation of the gas suction device. In this case, the gas-conducting unit can at least partially encompass the tool and/or the tool holder. It is also possible for the gas-conducting unit to essentially completely surround the tool and to at least partially surround the tool holder.

The shrinking device advantageously comprises a gas-conducting unit which encompasses a negative pressure region, the gas-conducting unit being provided for maintaining a negative pressure in the negative pressure region relative to an external region of the gas-conducting unit and a pressure drop from a receiving opening of the tool holder to the negative pressure region. The gas-conducting unit is designed in such a manner that, by means of the evacuation of gas from the gas-conducting unit, a negative pressure is produced within the gas-conducting unit and is maintained in the entire region by the shape of the gas-conducting unit during continuous evacuation of gas. By means of the, if appropriate, only slight negative pressure in the interior of the gas-conducting unit, the gas, which is mixed with residue vapors, in the interior of the gas-conducting unit is obstructed from emerging in significant quantities out of the gas-conducting unit into the surroundings, which are characterized by higher pressure. Reliable protection against emerging gases can be achieved. The gas-conducting unit encompasses the negative pressure region in such a manner that the negative pressure is retained. In this case, it can completely or only partially close off the negative pressure from the surroundings. It advantageously shields to the outside a region around the opening of the tool holder in order to maintain a negative pressure. The gas-conducting unit in each case at least partially surrounds, for example, only the tool and/or the tool holder. It is also possible for the gas-conducting unit to enclose the entire shrinking device or, if the shrinking device should be part of an apparatus, the entire apparatus.

The gas-conducting unit may have one or more openings through which the tool and, if appropriate, the tool holder or other parts of the shrinking device can protrude out of the gas-conducting unit or can protrude into the latter.

The gas suction device, if appropriate with a gas-conducting unit, may be arranged separately from the heating device and designed in a manner such that it can move independently of the heating arrangement. However, in one advantageous refinement, the heating device annularly encompasses the tool holder, and the gas-conducting unit is designed as a hood on the heating device. The heating device can therefore serve as a support for the gas-conducting unit which, as a result, does not have to be equipped with a dedicated suspension means or moveable fastening. The gas-conducting unit may be connected loosely or fixedly to the heating device. A loose gas-conducting unit may be taken away and returned separately from the tool holder. A gas-conducting unit connected fixedly to the heating device may be used as the suspension means and, if appropriate, the movement device of the heating device. A stable arrangement of the gas-conducting unit can be achieved without a further and separate suspension means.

A saving on components can also be achieved by the heating device forming part of the gas-conducting unit. In this case, the gas-conducting unit is arranged on the heating device during the evacuation operation, in which case a surface of the heating device, which surface faces the gas-conducting unit, serves to conduct the gas which is to be evacuated to a gas inlet opening.

In a further variant embodiment of the invention, the gas suction device has a gas inlet opening which is arranged in the interior of the tool holder. The vapors produced in the tool holder are thereby sucked on into the interior of the tool holder and to the gas inlet opening and are obstructed from emerging out of the opening of the tool holder into the surroundings. In the case of such a refinement of the shrinking device, a gas-conducting unit may be omitted, as a result of which freer mobility of the heating device can be achieved. In addition, the tool together with the tool holder can be set down at a location provided for the evacuation of gas, at which the tool is mounted or cooled transiently, for example, with it furthermore being possible for vapors escaping from the shank of the heated tool to be evacuated.

In order, with the tool situated in the tool holder, to ensure a flow of gas into the tool holder and to the gas inlet opening, it is expedient to design ducts for the supply of air in the tool holder. Ducts of this type may be incorporated, for example, in the inner surface of the tool holder, which surface faces the tool. It is also possible to provide ducts at another location in the tool holder, through which gas can be sucked from an external region of the tool holder, which region is situated at the tool shank, to the gas inlet opening. In the case of a shrinking device, in which the tool is first of all shrunk into a shrinking sleeve and the shrinking sleeve is shrunk into a shrinking chuck, the ducts may be arranged on the inside, outside or in the shrinking sleeve.

In one particularly advantageous refinement of the invention, the heating device has gas ducts which are provided for gas to flow through during the operation of the gas suction device. The heating device can be cooled by the gas, as a result of which the service life of the heating device is prolonged. The heating device is expediently cooled with air. During the heating of the tool holder by the heating device, the heating device is heated at the same time by the heat radiated by the tool holder. This results in an increased stress on the heating device. In order to remove the gas, which is mixed with liquid vapors, from the closer surroundings of the tool holder, it is necessary to bring air or gas from the more distant surroundings of the tool holder in order to use the air flow caused in this manner to transport away the gas which is to be removed. The air flow from the more distant surroundings of the tool chuck can be used for cooling the heating device. By guiding the cool air through gas ducts of the heating device, cooling of this type can be achieved in an effective manner. The cool air flow is guided first of all through the heating device and then to the gases which have escaped and are designated for transporting away.

The gas ducts are expediently connected to the negative pressure region by a gas line. The air to be conducted through the heating device can thereby be guided in as effective a manner as possible through the heating device and is guided through the gas line into the region in which it transports the liquid vapors to a gas inlet opening. The design of the gas channels is therefore independent of the location at which the liquid vapors arise.

In an alternative refinement of the invention, the gas ducts open into the negative pressure region. The air is therefore guided through the gas ducts into the immediate vicinity of the location at which the vapors arise and can then transport them away.

A further advantage is achieved if the tool chuck has an upper end surface at one end of the tool holder and the gas-conducting unit completely surrounds the tool holder above the end surface. Vapors which are heated and rise upward cannot escape out of the gas-conducting unit upward and can essentially be completely removed, for example through the gas inlet opening. For this purpose, the gas inlet opening can be arranged above the end surface, in which case the complete surrounding is also regarded as being satisfied in this case.

During heating of the tool holder, the majority of the gases will usually rise out of the holder opening. By means of a shielding element for resting on an upper end surface arranged at one end of the tool holder, the shielding element having a gas-conducting duct for conducting gas out of the tool holder opening, these gases can be directed in a specific manner, for example to a negative pressure region and/or to a gas inlet opening.

Multiple use of the shielding element can be achieved if the shielding element is provided for shielding a tool, which is inserted into the tool holder, from a magnetic field generated by the heating device. An additional magnetic-field-shielding element, which opposes a heating of the tool arranged in the holder opening, can be omitted.

A secure positioning of the heating device around the tool holder can be achieved if the shielding element is provided as a stop element for positioning the heating device. The shielding element is expediently connected fixedly to the heating device.

The shielding element can be provided for encompassing a tool arranged in the holder opening. If, however, as in the case of a shrinking process, no tool is arranged in the holder opening, a closing-off shielding element can be used. In this case, the shielding element upwardly closes off the holder opening in such a manner that gases rising out of the tool holder can only leave the holder opening upward through at least one gas-conducting duct in the shielding element. An undesirable outflow of vapors can be effectively opposed.

The invention is also based on a method for shrinking a tool into a tool holder, in which the tool holder is heated by a heating device. It is proposed that gases are evacuated from the tool holder with the aid of a gas suction device. An undesirable propagation of gases rising out of or at the tool holder can be effectively opposed.

### DRAWING

Further advantages emerge from the drawing description below. The drawing illustrates exemplary embodiments of the invention. The drawing, the description and the claims contain numerous features in combination. The expert will expediently also consider the features individually and put them together to form meaningful further combinations.

In the drawing:

FIG. 1 shows a schematic illustration of a tool setting and measuring apparatus with a shrinking device,

FIG. 2 shows a section through a shrinking device with a gas suction device in a schematic illustration,

FIG. 3 shows an alternative embodiment to FIG. 2 of a heating device and gas-conducting device,

FIG. 4 shows a further embodiment of a gas suction device with a shielding element,

FIG. 5 shows a further sectional illustration of the gas suction device from FIG. 4,

FIG. 6 shows a plan view of the shielding element from FIG. 5, and

FIG. 7 shows a sectional illustration of a further shielding element on the tool holder.

### DESCRIPTION OF THE EXEMPLARY EMBODIMENTS

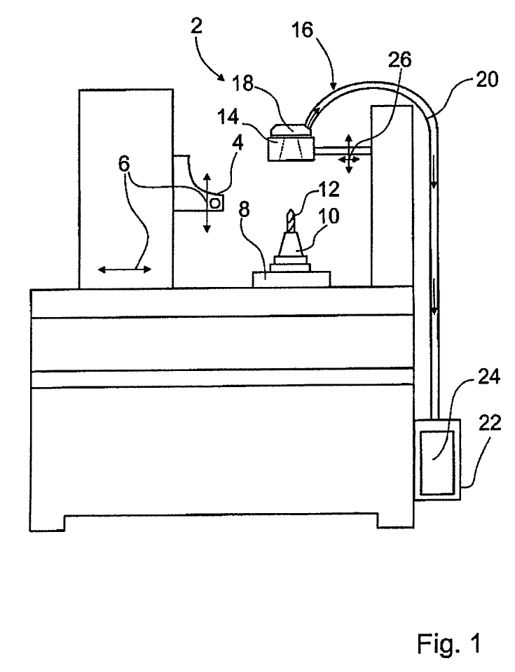

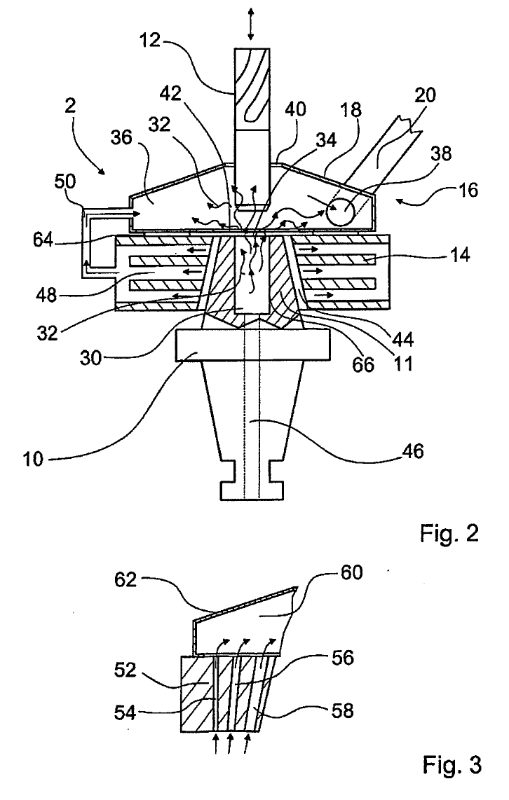

FIG. 1 shows a device which is designed as a tool setting and measuring apparatus and has a shrinking device 2. The device has a measuring device 4 for optically measuring tool parameters. The measuring device 4 can be moved in the directions shown by the arrows 6. The device also comprises a rotatable tool chuck holder 8 for holding a tool chuck 10, which is designed as a shrinking chuck and has a tool holder 11 (FIG. 2). A tool 12 is shrunk into the tool holder 11 by the shrinking device 2 by a heating device 14 being arranged around the tool holder 11 and heating the tool holder 11. For this purpose, the heating device 14 can be moved in accordance with the directions illustrated by the arrows 26. The heating device 14 operates on the eddy current principle and comprises an induction coil for this. A gas suction device 16 which comprises a gas-conducting unit 18 and a gas line 20 connected thereto is connected to the heating device 14. The gas line 20 opens into a fan unit 22 of the gas suction device 16, in which a cleaning device 24 for cleaning the gases flowing through it is integrated.

FIG. 2 schematically illustrates parts of the shrinking device 2 in enlarged form. A hole 30 is made in the tool holder 11 and is provided for holding the tool 12. In order to shrink the tool 12 into the tool holder 11, the heating device 14, which is of annular design, is arranged around the tool holder 11. By means of an induction current, the metallic material of the tool holder 11 around the hole 30 is heated. The tool 12 is positioned above the hole 30 in a waiting position. As the temperature of the metallic material rises, more and more oil residues evaporate as gases 32 which are are retained in the hole 30 or on the tool holder 11 by a tool which has previously been shrunk in the shrinking chuck. In particular when unshrinking the tool 12, any residues from a machining process just ended that are still moist and adhere to the or in the tool 12 or tool holder 11 are heated. They evaporate and escape from the tool 12, from the tool holder 11 or, in the case of the tool 12 (as shown in FIG. 2) which has already been lifted out of the hole 30, from the hole 30.

The gases 32 pass into a negative pressure region 36 around the opening 34 of the tool holder 11 and, without the gas suction device 16, would be distributed into the more distant surroundings. This further distribution is prevented by the gas-conducting unit 18 which shields off the negative pressure region 36 to the outside in order to maintain a negative pressure. By means of the fan unit 22, the gas line 20 and a gas inlet opening 38, gas is evacuated from the negative pressure region 36 shielded by the gas-conducting unit 18, so that a negative pressure in comparison to the external region of the gas-conducting unit 18 is produced in this region. This negative pressure is maintained by the gas-conducting unit 18.

The gas evacuated through the gas inlet opening 38 is sucked up from various openings of the gas-conducting unit 18. A first opening 40 in the gas-conducting unit 18 serves to let through the tool 12 from above into the hole 30 of the tool holder 11. The first opening 40 is designed in such a manner that, even with the tool 12 inserted, gas—usually ambient air—can flow through the opening 40 into the negative pressure region 36. A second opening 42 which is larger than the first opening 40 is made on the underside of the gas-conducting unit 18. Like the first opening 40, the second opening 42 also serves to let through the tool 12 into the hole 30 and to supply air into the negative pressure region 36.

The air flowing in through the second opening 42 can flow from the outside into the negative pressure region 36 through one or more slots 44 between the tool holder 11 and the heating device 14. It is also possible for the tool holder 11 to have an inner hole 46 in which a positioning device (not shown specifically in the figures) can be arranged. Air sucked in can pass from the hole 46 into the hole 30 in order to flow on from there through the opening 34 and the second opening 42 into the negative pressure region 36. By means of the gas and air flows described, the liquid vapor arising at the tool 12 or the tool holder 11 is guided, directed by the gas-conducting unit 18, to the gas inlet opening 38 of the gas suction device 16. The vapors do not emerge into the surroundings of the gas suction device 16.

A further air flow is guided directly through the heating device 14. For this purpose, the heating device 14 has gas ducts 48 through which air can flow from one of the slots 44 through the heating device 14 and on to a gas line 50. The gas line 50 opens into the negative pressure region 36 from where the air flow, carrying along the residue vapors, is sucked to the gas inlet opening 38. The air flow directed through the heating device 14 causes a cooling of the heating device, which is heated by the radiation of heat from the tool holder 11. This cooling enables the service life of the heating device 14 to be prolonged. The gas ducts 48, which are shown in sectional form in FIG. 2 and are designed as holes, run within the heating device in such a manner that, at the point which faces the tool holder 11 and is heated the most by the latter, the cool air flows into the heating device 14. By this means, this point which is heated the most is cooled the most.

An alternative refinement of a heating device 52 and of a gas-conducting unit 62 is shown in FIG. 3. Gas ducts 54, 56, 58, of which three are shown in FIG. 3, are made in the heating device 52, which essentially comprises an induction coil. Air can flow from below the heating device 52 through the heating device 52 directly into the negative pressure region 60 of the gas-conducting unit 62 through the gas ducts 54, 56, 58. The gas ducts 54, 56, 58 open directly into the negative pressure region 60. In contrast to the gas-conducting unit 18 from FIG. 2, the gas-conducting unit 62 from FIG. 3 is essentially open downward toward the heating device 52, so that air can flow out of the gas ducts 54, 56, 58 without interference into the negative pressure region 60. The gas ducts 54, 56, 58 are designed in such a manner that the widest gas duct 58 is placed in the region in which there is the greatest formation of heat. A second gas duct 56, which is of somewhat smaller design in sense of its cross section than the gas duct 58, is placed somewhat further away from the heat-radiating tool holder (not shown). The gas duct 54 having the smallest flow cross section is placed even further away. The shape and routing away of the gas ducts 54, 56, 58 and 48 can be designed in a manner regarded as suitable by an expert. The gas-conducting units 18 and 62 shown in FIGS. 2 and 3 are designed in each case as a hood on the heating devices 14 and 52, respectively. The gas-conducting unit 18 is fastened to the heating device 14 by means of small stands 64. The gas-conducting unit 18 is therefore supported by the heating device 14, with the result that it does not require a separate suspension means. The gas-conducting unit 62 is designed such that it rests on the heating device 52, with it also being possible to fasten the gas-conducting unit 62 directly on the heating device 52. The gas-conducting unit 62 is open downward, a surface of the heating device 52 forming part of the gas-conducting unit 62. The gas-conducting unit 62 has a suspension means (not shown in FIG. 3) by means of which the gas-conducting unit 62 can be moved separately from the heating device 52 to a tool holder or a tool or away from the latter.

In an alternative refinement of the invention, it is also possible to connect the fan unit 22 to the hole 46 in the tool holder 11 and to evacuate gases directly downward out of the hole 30 of the tool holder 11. Residue vapors arising in the hole 30 are thus not able to emerge from the hole 30 at all. In addition, an evacuation of gas can also be continued if the heating device 14 is moved away from the tool holder 11. In order to enable an evacuation of gas even when the tool 12 is shrunk in, ducts which are incorporated in the surface 66 of the hole 30 can be provided, in which gas or air can flow in to the hole 46 from above the tool holder 11. By this means, an effective evacuation of gas can be achieved even when the tool is shrunk in.

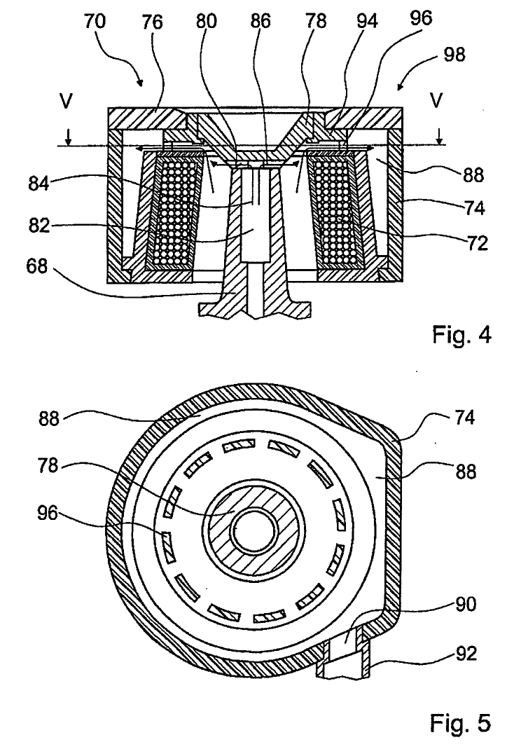

FIG. 4 shows a further shrinking device 70, which is arranged around a tool holder 68, with a heating device 72 designed as an inductor. The heating device 72 is held by a housing 74 of the shrinking device 70 which, in turn, has a hinged cover 76. In the locked state, the cover 76 is supported on a shielding element 78, which is arranged in an opening of the cover 76 and rests on an upper end surface 80 of the tool holder 68, which end surface is arranged at one end of the tool holder 68. When the shrinking device 70 is lowered around the tool holder 68, the shielding element 78 serves as a stop for positioning the heating device 72 in a position suitable for heating the tool holder 68.

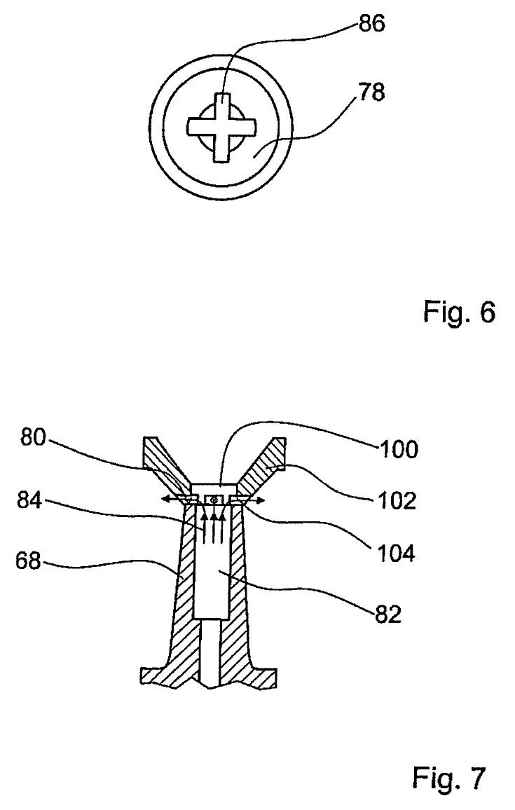

In order to evacuate gases 84 rising in the holder opening 82 of the tool holder 68, two gas-conducting ducts 86 are placed in a cross-shaped manner into the underside of the shielding element 78. FIG. 6 shows these gas-conducting ducts 86 in a view from below of the shielding element 78. The gases 84 are directed through the gas-conducting ducts 86 into a negative pressure region 88 which is connected by a gas inlet opening 90 to a gas line 92 (FIG. 5). Gases 84 are evacuated from the negative pressure region 88 through the gas line 92 and are supplied to a fan unit 22, for example as illustrated in FIG. 1. The gases 84 flowing through the gas-conducting ducts 86 are sucked below a supporting element 94 and between webs 96 into the negative pressure region 88. The webs 96 are connected integrally to the supporting element 94 which, in turn, is connected fixedly to the shielding element 78.

By means of the gas-conducting unit 98, which comprises the housing 74, the cover 76 and the shielding element 78 and completely surrounds the tool holder 68 above the end surface 80 up to the gas inlet opening 90, gases 84 rising upward out of the holder opening 82 cannot penetrate out of the gas-conducting unit 98 and into the surroundings. Evaporating gases rising on the outside of the tool holder 68 are likewise sucked into the negative pressure region 88 below the supporting element 94 or between the webs 96. The closed shielding element 78, which closes the holder opening 82 upward—up to the gas-conducting ducts 86—is suitable in particular for a shrinking operation, in which no tool 12 is arranged in the holder opening 82 during the heating of the tool holder 68.

A shielding element 102 provided with a passage opening 100 is shown in a sectional illustration in FIG. 7. It likewise rests on the end surface 80 of the tool holder 68 and comprises gas-conducting ducts 104, which are arranged in a crosswise manner on its underside, for guiding gases 84 rising out of the holder opening 82 to a negative pressure region 88 (as illustrated in FIG. 4) encompassed by a gas-conducting unit 98. The shielding element 102 is used in particular for unshrinking a tool 12 out of the tool holder 68 and serves for shielding a tool 12, which is inserted in the holder opening 82, from a magnetic field generated by the heating device 72, so that the tool 12 does not heat and expand too rapidly. By means of the suction drawing toward the negative pressure region 88, gases 84 are prevented from passing through upward from the holder opening 82 through the passage opening 100, so that the surroundings are also shielded from the gases 84 by the shielding element 102.

### Reference Numbers

2 Shrinking device
4 Measuring device
6 Arrow
8 Tool chuck holder
10 Tool chuck
11 Tool holder
12 Tool
14 Heating device
16 Gas suction device
18 Gas-conducting unit
20 Gas line
22 Fan unit
24 Cleaning device
26 Arrow
30 Hole
32 Gas
34 Opening
36 Negative pressure region
38 Gas inlet opening
40 First opening
42 Second opening
44 Slot
46 Hole
48 Gas duct
50 Gas line
52 Heating device
54 Gas duct
56 Gas duct
58 Gas duct
60 Negative pressure region
62 Gas-conducting unit
64 Stand
66 Surface
68 Tool holder
70 Shrinking device
72 Heating device
74 Housing
76 Cover
78 Shielding element
80 End surface
82 Holder opening
84 Gas
86 Gas-conducting duct
88 Negative pressure region
90 Gas inlet opening
92 Gas line
94 Supporting element
96 Web
98 Gas-conducting unit
100 Passage opening
102 Shielding element
104 Gas-conducting duct

1. A shrinking device for shrinking a tool into a tool holder of a tool chuck, the shrinking device comprising:
a heating device for heating the tool holder; and
a gas suction device for evacuating gases escaping from the tool holder.

2. The shrinking device as claimed in claim 1, further comprising a gas-conducting unit for conducting gas from a holder opening of the tool holder to a gas inlet opening of the gas suction device.

3. The shrinking device as claimed in claim 1, further comprising a gas-conducting unit which encompasses a negative pressure region, the gas-conducting unit being provided for maintaining a negative pressure in the negative pressure region relative to an external region of the gas-conducting unit and a pressure drop from a holder opening of the tool holder to the negative pressure region.

4. The shrinking device as claimed in claim 2, wherein the heating device annularly encompasses the tool holder and the gas-conducting unit is designed as a hood on the heating device.

5. The shrinking device as claimed in claim 2, wherein the heating device forms part of the gas-conducting unit.

6. The shrinking device as claimed in claim 2, wherein the heating device has gas ducts which are provided for gas to flow through during the operation of the gas suction device.

7. The shrinking device as claimed in claim 3, wherein the gas ducts are connected to the negative pressure region by a gas line.

8. The shrinking device as claimed in claim 3, wherein the gas ducts open into the negative pressure region.

9. The shrinking device shrinking device as claimed in claim 2, wherein the tool chuck has an upper end surface arranged at one end of the tool holder and the gas-conducting unit completely surrounds the tool holder above the end surface.

10. The shrinking device as claimed in claim 1, further comprising a shielding element for resting on an upper end surface arranged at one end of the tool holder, the shielding element having a gas-conducting duct for conducting gas out of the holder opening.

11. The shrinking device as claimed in claim 10, wherein the shielding element is provided for shielding a tool, which is inserted into the tool holder, from a magnetic field generated by the heating device.

12. The shrinking device as claimed in claim 10, wherein the shielding element is provided as a stop element for positioning the heating device.

13. The shrinking device as claimed in claim 10, wherein the shielding element upwardly closes off the holder opening in such a manner that gases rising out of the holder opening can only leave the holder opening upward through at least one gas-conducting duct in the shielding element.

14. A method for shrinking a tool into a tool holder of a tool chuck, the method comprising:
heating the tool holder by a heating device; and
evacuating gases from the tool holder with the aid of a gas suction device.
